(19) United States
(12) Patent Application Publication
(10) Pub. No.: US 2014/0313403 A1
(43) Pub. Date: Oct. 23, 2014

(54) CAMERA MODULE HAVING AMBIENT LIGHT SENSOR

(71) Applicant: HON HAI PRECISION INDUSTRY CO., LTD., New Taipei (TW)

(72) Inventor: SHIN-WEN CHEN, New Taipei (TW)

(73) Assignee: HON HAI PRECISION INDUSTRY CO., LTD., New Taipei (TW)

(21) Appl. No.: 14/014,430

(22) Filed: Aug. 30, 2013

(30) Foreign Application Priority Data
Apr. 23, 2013 (TW) 102114466

(51) Int. Cl. H04N 5/225

(52) U.S. Cl. CPC H04N 5/2254
USPC 348/373

(57) ABSTRACT

A camera module facilitating the assembly therewith of an ambient light sensor includes a flexible printed circuit board (FPCB), a lens module, and a case. The FPCB includes a ground layer. The lens module is positioned on and connected to the FPCB. The case includes a front surface and a rear surface opposite to the front surface, and defines a receiving recess running through the front surface and the rear surface. A metal layer is coated on an inner surface of the receiving recess and the rear surface to isolate an image sensor of the camera module from the incident light experienced by the ambient light sensor. The case is supported on the FPCB and the lens module is received in the receiving recess. The metal layer is electrically connected to the ground layer.

### BACKGROUND

1. Technical Field

The present disclosure relates to camera modules and, particularly, to a camera module having an ambient light sensor.

2. Description of Related Art

Camera modules include a case, an ambient light sensor, and a flexible printed circuit board (FPCB). The case includes a rear surface and a front surface opposite to the rear surface. The FPCB is attached to the rear surface while the ambient light sensor is attached to the front surface. The ambient light sensor detects ambient light intensity and transmits the detected intensity. As such, the FPCB needs to extend from the rear surface to the front surface, be bent around corners, and electrically connected with the ambient light sensor, which make it difficult to assemble the camera module and increases cost.

Therefore, it is desirable to provide a camera module that can overcome the limitations described.

### BRIEF DESCRIPTION OF THE DRAWINGS

FIG. 1 is a schematic view of a camera module in accordance with an exemplary embodiment.

FIG. 2 is an isometric, exploded, and schematic view of the camera module of FIG. 1.

FIG. 3 is similar to FIG. 2, but viewed from another angle.

### DETAILED DESCRIPTION

Embodiments of the disclosure will be described with reference to the drawings.

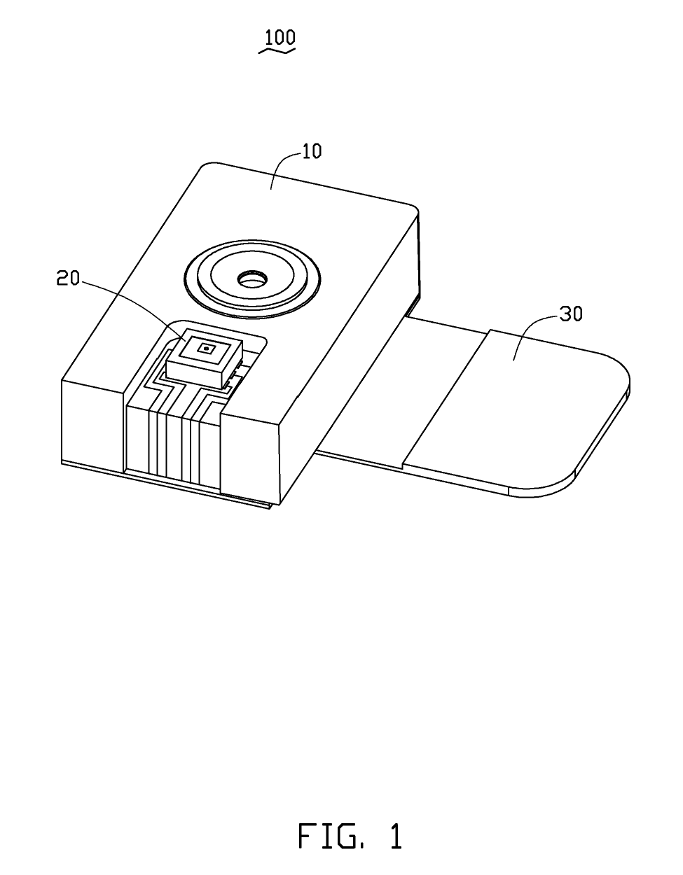

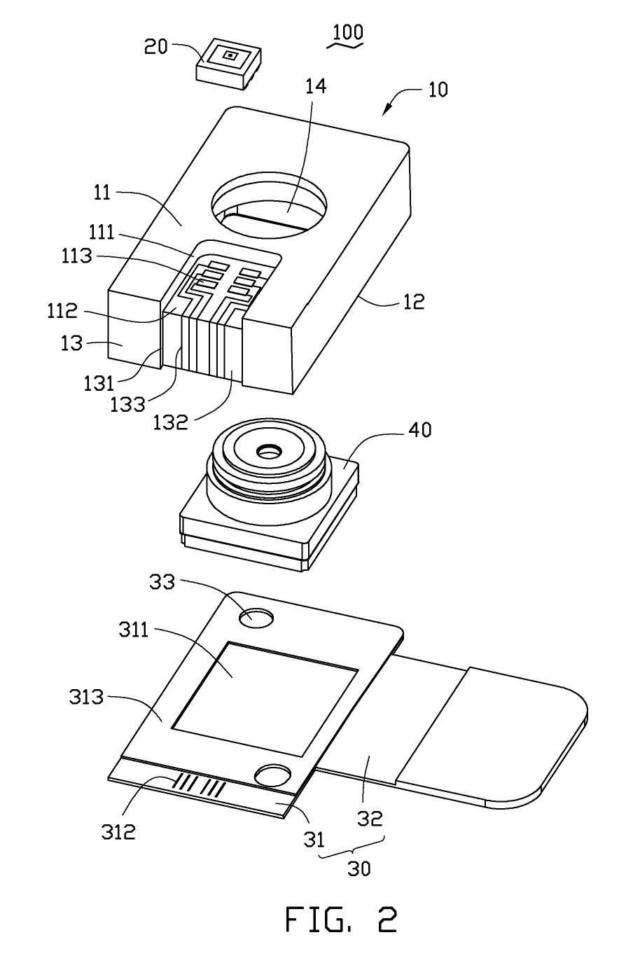

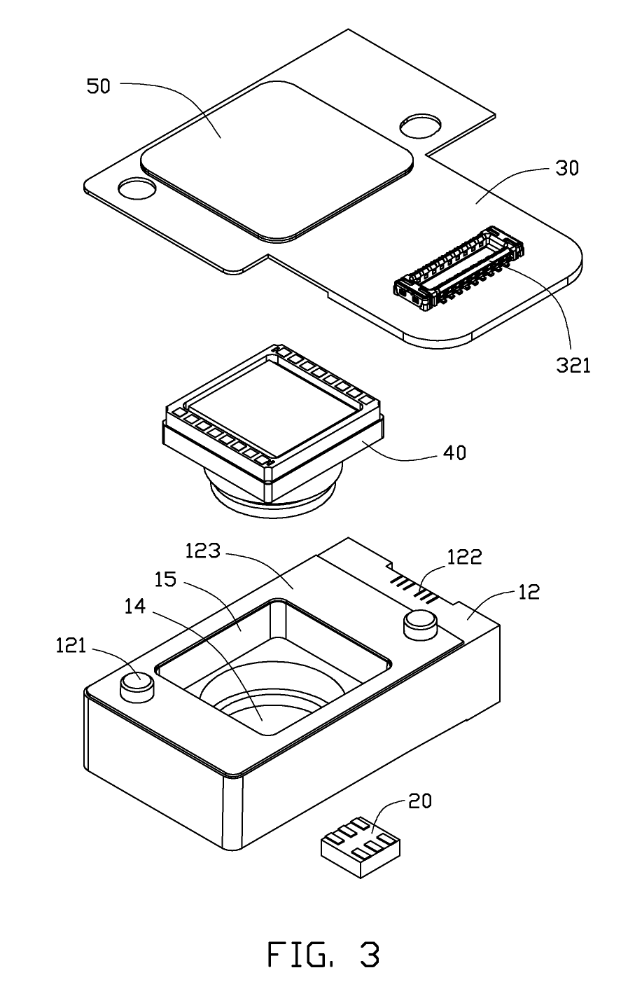

FIGS. 1-3 show a camera module 100, according to an exemplary embodiment. The camera module 100 can be used in an electrical device (not shown) and includes a case 10, an ambient light sensor 20, an FPCB 30, a lens module 40, and a stiffener board 50.

The case 10 is rectangular, and includes a front surface 11, a rear surface 12, and a side surface 13. The rear surface 12 is opposite to the front surface 11. The side surface 13 is connected between the front surface 11 and the rear surface 12. The case 10 defines a receiving recess 14 running through the rear surface 12 and the front surface 11. The receiving recess 14 includes an inner surface 15.

The case 10 defines a first strip recess 111 on the front surface 11. The first strip recess 111 runs through the side surface 13. The first strip recess 111 includes a first mounting surface 112. The case 10 defines a second strip recess 131 on the side surface 13. The second strip recess 131 communicates with the first strip recess 111, and runs through the rear surface 12. The second strip recess 131 includes a second mounting surface 132. In the embodiment, the first mounting surface 112 can be taken as a part of the front surface 11, and the second mounting surface 132 can be taken as a part of the side surface 13. At least two position poles 121 diagonally extend downward from the rear surface 12.

A number of first electrical pads 113 are mounted on the first mounting surface 112. A number of second electrical pads 122 are mounted on the rear surface 12, generally adjacent to an edge of the rear surface 12. The first electrical pads 113 connect to the second electrical pads 122 via wires 133 laid on the second mounting surface 132. A metal layer 123 is coated on the rear surface 12 except for an area under the second electrical pads 122. The metal layer 123 is also coated on the inner surface 15.

In the embodiment, the first electrical pads 113, the wires 133, the second electrical pads 122, and the metal layer 123 are formed on the case 10 by a laser direct molding technology. The laser direct molding technology includes steps of activating circuit tracks on the case 10 via a laser according to a designed scheme, and copper, nickel, and gold are plated in order on the circuit tracks.

The ambient light sensor 20 is received in the first strip recess 111, and is electrically connected to the first electrical pads 113. The ambient light sensor 20 is configured for detecting an ambient light intensity.

The FPCB 30 includes a supporting portion 31 and a connecting portion 32 connected to the supporting portion 31. The supporting portion 31 defines an electrical connecting area 311 at a center thereof. A number of third electrical pads 312 are mounted on the supporting portion 31 beyond the electrical connecting area 311, generally adjacent to an edge of the supporting portion 31. The third electrical pads 312 and the electrical connecting area 311 are positioned at a same side of the supporting portion 31. At least two position holes 33 are diagonally defined on the supporting portion 31. A ground layer 313 is coated on the supporting portion 31 except for the electrical connecting area 311 and also except for an area under the third electrical pads 312. A size of the supporting portion 31 is substantially equal to a size of the rear surface 12.

The connecting portion 32 includes a connector 321. The connector 321 and the electrical connecting area 311 are positioned at opposite sides of the FPCB 30. The camera module 100 outputs electrical signals via the connector 321.

The lens module 40 is electrically connected to the electrical connecting area 311 of the supporting portion 31. The lens module 40 is configured for converting light into electrical signals. The lens module 40 includes an image sensor and a lens.

The stiffener board 50 is a plate, and is made of material having high strength and rigidity, such as stainless steel. The stiffener board 50 is attached on a side of the supporting portion 31 opposite to the electrical connecting area 311.

The camera module 100 further includes a flash lamp module (not shown) facing the front surface 11 of the case 10. The flash lamp module emits light of different intensities depending on the ambient light intensity of the camera module 100 as detected by the ambient light sensor 20.

The camera module 100 further includes a display (not shown) facing the rear surface 12 of the case 10. The luminance of the display is also adjusted according to the ambient light intensity of the camera module 100 as detected by the ambient light sensor 20.

In assembly, the case 10 is positioned on the FPCB 30. The position poles 121 are received in the position holes 33. The metal layer 123 is electrically connected to the ground layer 313 with a conductive glue. The lens module 40 is received in the receiving recess 14, and the metal layer 123 surrounds the lens module 40. The lens module 40 and the ambient light sensor 20 face the same direction. The second electrical pads 122 electrically connect to the third electrical pads 312.

In use, the ambient light sensor 20 detects ambient light intensity, and outputs the detected light intensity to the FPCB 30 via the first electrical pads 113, the wires 133, the second electrical pads 122, and the third electrical pads 312. The camera module 100 chooses different capturing characteristics for images according to the ambient light intensity of the camera module 100. As the lens module 40 is surrounded by the metal layer 123, the lens module 40 is not be disturbed by an external environment.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A camera module, comprising:
a flexible printed circuit board (FPCB) comprising a ground layer coated thereon;
a lens module electrically positioned on the FPCB;
a case comprising a front surface, a rear surface opposite to the front surface, and a side surface connected between the front surface and the rear surface; the case defining a receiving recess running through the front surface and the rear surface; a plurality of first electrical pads mounted on the front surface, a number of second electrical pads mounted on the rear surface, wires connected between the first electrical pads and the second electrical pads laid on the side surface; a metal layer coated on an inner surface of the receiving recess and the rear surface; the case supported by the FPCB and the lens module received in the receiving recess; the second electrical pads electrically connected to the FPCB, and the metal layer electrically connected to the grounded layer; and
an ambient light sensor electrically connected to the first electrical pads.

2. The camera module of claim 1, wherein the FPCB comprises a supporting portion and a connecting portion connected to the supporting portion, the FPCB defines an electrical connecting area, and the lens module is electrically connected to the electrical connecting area.

3. The camera module of claim 2, wherein a plurality of third electrical pads are mounted on the supporting portion beyond the electrical connecting area, the third electrical pads are electrically connected to the second electrical pads.

4. The camera module of claim 3, wherein the ground layer is coated on the supporting portion except for the electrical connecting area and also except for an area under the third electrical pads.

5. The camera module of claim 2, wherein a stiffener board is attached on a side of the supporting portion opposite to the electrical connecting area.

6. The camera module of claim 1, wherein the metal layer is coated on the rear surface except for an area under the second electrical pads.

7. The camera module of claim 1, wherein the lens module and the ambient light sensor face the same direction.

8. A camera module, comprising:
an FPCB comprising a ground layer coated thereon;
a lens module electrically positioned on the FPCB; and
a case comprising a front surface and a rear surface opposite to the front surface, the case defining a receiving recess running through the front surface and the rear surface; a metal layer coated on an inner surface of the receiving recess and the rear surface; the case supported by the FPCB and the lens module received in the receiving recess; the metal layer electrically connected to the grounded layer.
